(19) United States
(12) Patent Application Publication
(10) Pub. No.: US 2025/0027214 A1
(43) Pub. Date: Jan. 23, 2025

(54) GAS PHASE DIFFUSION ELECTRODE, PREPARATION METHOD, AND APPLICATION FOR ELECTROCATALYZING CO2 TO REDUCE AND PRODUCE FORMIC ACID

(71) Applicants: SHENZHEN INSTITUTES OF ADVANCED TECHNOLOGY, SHENZHEN (CN); CHINA MERCHANTS. INVESTMENT DEVELOPMENT COMPANY LIMITED, SHENZHEN (CN)

(72) Inventors: XIAOLONG ZHANG, SHENZHEN (CN); JUXIA XIONG, SHENZHEN (CN); YINGJUN DONG, SHENZHEN (CN); HUIMING CHENG, SHENZHEN (CN)

(21) Appl. No.: 18/481,205

(22) Filed: Oct. 4, 2023

Related U.S. Application Data
(63) Continuation of application No. PCT/CN2023/108498, filed on Jul. 21, 2023.

(51) Int. Cl. C25B 11/032; C25B 3/07; C25B 3/26; C25B 11/052; C25B 11/075

(52) U.S. Cl. CPC C25B 11/032; C25B 3/07; C25B 3/26; C25B 11/052; C25B 11/075

(57) ABSTRACT

The present application provides a preparation method of a gas phase diffusion electrode for electrocatalyzing CO₂ to reduce and produce formic acid and an application thereof, comprising: obtaining first mixed solution, obtaining second mixed solution, uniformly mixing the first mixed solution and the second mixed solution, coating them onto a surface of a substrate, and then placing them at a temperature of −30° C.-100° C. for 1-48 hours to obtain the gas phase diffusion electrode. In the preparation method, conductive polymer monomer and bismuth or tin based metal component are coated onto the surface of the substrate to form an integrated conductive polymer-catalyst/hydrophobic substrate composite gas phase diffusion electrode, not only can the stability between metal active components and the substrate material be enhanced, but also characteristics such as better conductivity, higher specific surface area, abundant surface chemical reaction sites, and so on are provided.

### CROSS REFERENCE TO RELATED APPLICATIONS

The present application is a continuation of co-pending International Patent Application No. PCT/CN2023/108498, filed on Jul. 21, 2023. The entire contents of the above-identified applications are incorporated herein by reference.

### TECHNICAL FIELD

The present application relates to the technical field of reduction by electrocatalyzing CO₂, and in particular, to a preparation method and application of a gas phase diffusion electrode for electrocatalyzing CO₂ to reduce and produce formic acid.

### BACKGROUND

In CO₂ molecules, the C═O bond length is 1.16 Å and the bond energy is as high as 750 KJmol⁻¹, resulting in that it has high thermodynamic stability and difficulty in activation. Therefore, sufficient energy needs to be provided to overcome the reaction energy barrier during a CO₂ conversion process. According to the form of energy supply, reduction and conversion of CO₂ can be divided into three conversion methods: thermochemical, photochemical, and electrochemical. The thermochemical conversion represented by CO₂ hydrogenation reaction received the earliest research and attention. For example, in the 1970s, the British Imperial Chemical Industry Company developed a Cu/ZnO/Al₂O₃ commercial catalyst for the preparation of methanol at 200-300° C. and 50-100 atm conditions. In addition, high carbon products such as methane, formic acid, as well as olefins, gasoline, and so on can also be produced through thermochemical conversion technology. However, the thermochemical conversion of CO₂ has harsh reaction conditions and usually requires being performed under a high temperature and a high pressure. Compared with the thermochemical conversion, the photochemical conversion of CO₂ has much milder reaction conditions. In the photochemical conversion, photo generated electrons generated by semi-conducting catalysts under irradiation by sunlight can reduce CO₂. However, there are still problems, such as poor selectivity of products, a low generation rate, and so on existing in the current photochemical conversion of CO₂, which are difficult to meet industrial applications.

Compared with the thermochemical conversion and the photochemical conversion, the electrochemical conversion of CO₂ has the following advantages: mild reaction conditions, which can be carried out at a normal temperature and a normal pressure; a controllable reaction process, wherein selectivity and a generation rate of a product can be regulated by changing a potential, catalyst, and electrolyte; using electricity generated by renewable energy sources (wind energy, solar energy, etc.) as a driving force can achieve a carbon neutral cycle; a modular reaction system which is easy to achieve industrial production. Therefore, the prospect of reducing CO₂ concentration in the atmosphere through the electrochemical conversion of CO₂ is enormous.

Formic acid (HCOOH) products, as a 2e⁻ reduction product, have been extensively studied in CO₂ electroreduction reactions. Catalysts with HCOOH selectivity mainly include the p-region main group metal elements In, Sn, Sb, Tl, Pb, Bi, as well as transition metal elements Co, Cu, Pd, Cd, Hg, etc. With the development of more and more efficient catalysts, selectivity and activity of HCOOH products are also steadily improving. Due to the weak adsorption of *H, Bi based catalysts can inhibit the occurrence of competitive reaction HER to some extent in CO₂ electroreduction reactions, resulting in better selectivity for HCOOH products. However, traditional powder Bi based catalysts have poor conductivity and low current density, and are prone to fall off during electrolysis processes, resulting in low stability and efficiency during a long time, which limits practical industrial applications.

### SUMMARY OF THE DISCLOSURE

In view of this, aiming at the defect that conventional electrodes are low in selectivity, poor in stability, and poor conductivity for electrocatalyzing CO₂ to reduce and produce formic acid, it is necessary to provide a preparation method of a gas phase diffusion electrode, a gas phase diffusion electrode, and an application thereof which have low cost, high selectivity, good conductivity, and excellent stability.

In order to solve the above problems, the present application adopts the following technical solutions.

A first purpose of the present application provides a preparation method of a gas phase diffusion electrode for electrocatalyzing CO₂ to reduce and produce formic acid and an application thereof, comprising the following steps: obtaining first mixed solution, wherein the first mixed solution comprises mixed solution of acidic solution, solvent, dispersant, and conductive polymer monomer; obtaining second mixed solution, wherein the second mixed solution comprises component containing bismuth or tin and solvent mixed solution; uniformly mixing the first mixed solution and the second mixed solution, coating them onto a surface of a substrate, and then placing them at a temperature of −30° C.-100° C. for 1-48 hours to obtain a gas phase diffusion electrode.

In some embodiments thereof, in the step of obtaining first mixed solution, wherein the first mixed solution comprises mixed solution of acidic solution, solvent, dispersant, and conductive polymer monomer, the molar ratio of the conductive polymer monomer to the acidic solution is 1:1-20.

In some embodiments thereof, in the step of obtaining first mixed solution, wherein the first mixed solution comprises mixed solution of acidic solution, solvent, dispersant, and conductive polymer monomer, the acidic solution comprises one or more of hydrochloric acid, sulfuric acid, nitric acid, formic acid, acetic acid, dodecylbenzenesulfonic acid, p-toluenesulfonic acid, and camphor sulfonic acid.

In some embodiments thereof, in the step of obtaining first mixed solution, wherein the first mixed solution comprises mixed solution of acidic solution, solvent, dispersant, and conductive polymer monomer, the solvent is one or more of water, methanol, ethanol, isopropanol, acetonitrile, ethyl acetate, chloroform, dichloromethane, acetone, N-methylpyrrolidone, dimethylformamide, and dimethyl sulfoxide.

In some embodiments thereof, in the step of obtaining first mixed solution, wherein the first mixed solution comprises mixed solution of acidic solution, solvent, dispersant, and conductive polymer monomer, the conductive polymer monomer is one or more of aniline, pyrrole, thiophene, indole, pyridine, carbazole, dopamine, and p-phenylacetylene monomers.

In some embodiments thereof, in the step of obtaining first mixed solution, wherein the first mixed solution comprises mixed solution of acidic solution, solvent, dispersant, and conductive polymer monomer, the dispersant is one or more of isopropanol, methanol, ethanol, ethyl acetate, acetonitrile, N-methylpyrrolidone, and dimethylformamide.

In some embodiments thereof, in the step of obtaining second mixed solution, wherein the second mixed solution comprises component containing bismuth or tin and solvent mixed solution, the component containing bismuth or tin comprises one or more of bismuth nitrate, bismuth sulfate, bismuth acetate, bismuth oxycarbonate, bismuth chloride, bismuth bromide, bismuth iodide, bismuth salicylate, bismuth powder, bismuth oxide powder, bismuth sulfide powder, stannous chloride, tin tetrachloride, tin oxide powder, and tin sulfide powder.

In some embodiments thereof, the molar concentration of the component containing bismuth or tin is controlled between 0.01-5 mol/L.

In some embodiments thereof, in the step of uniformly mixing the first mixed solution and the second mixed solution, coating them onto a surface of a substrate, and then placing them at a temperature of −30° C.-100° C. for 1-48 hours to obtain a gas phase diffusion electrode, the coating comprises one of drip coating, spray coating, scraping coating, and spin coating.

In some embodiments thereof, the substrate comprises polytetrafluoroethylene, polyethylene, polyvinylidene fluoride, non-woven fabrics, fiber resin films, and modified substrate materials thereof.

In some embodiments thereof, before the step of uniformly mixing the first mixed solution and the second mixed solution, coating them onto a surface of a substrate, the method further comprises: cleaning the substrate several times with water and/or organic solvent, and drying.

A second purpose of the present application provides a gas phase diffusion electrode for electrocatalyzing CO₂ to reduce and produce formic acid, which is obtained by preparation by the preparation method according to any one of the above.

A third purpose of the present application provides an application of a gas phase diffusion electrode for electrocatalyzing CO₂ to reduce and produce formic acid.

The present application adopts the above-described technical solutions, and its advantageous effect is as follows.

The present application provides a preparation method of a gas phase diffusion electrode for electrocatalyzing CO₂ to reduce and produce formic acid and an application thereof, comprising: obtaining first mixed solution, wherein the first mixed solution comprises mixed solution of acidic solution, solvent, dispersant, and conductive polymer monomer; obtaining second mixed solution, wherein the second mixed solution comprises component containing bismuth or tin and solvent mixed solution; uniformly mixing the first mixed solution and the second mixed solution, coating them onto a surface of a substrate, and then placing them at a temperature of −30° C.-100° C. for 1-48 hours to obtain a gas phase diffusion electrode. In the preparation method of a gas phase diffusion electrode of the present application, conductive polymer monomer and bismuth or tin based metal component are coated onto the surface of the substrate to form an integrated conductive polymer-catalyst/hydrophobic substrate composite gas phase diffusion electrode, not only can the stability between metal active components (metal salts, metal particles, metal ligand complexes, etc.) and the substrate material be enhanced, but also characteristics such as better conductivity, higher specific surface area, abundant surface chemical reaction sites, and so on are provided. Rapid adsorption and activation of CO₂ molecules during the reaction process is facilitated, such that excellent catalytic activity and stability are exhibited in electrocatalytic CO₂ reduction electrolysis cells.

Furthermore, the present application provides a gas phase diffusion electrode for electrocatalyzing CO₂ to reduce and produce formic acid, which is environmentally friendly, low in price, efficient and stable, and can efficiently realize reducing CO₂ by electrocatalyzing to produce formic acid, thereby having prospect for large-scale industrial application.

### BRIEF DESCRIPTION OF THE DRAWINGS

In order to explain technical solutions of embodiments of the present application more clearly, drawings required to be used in description of the embodiments of the present application or of the prior art will be briefly introduced below. It is obvious that the drawings in the following description are only some embodiments of the present application. For one of ordinary skill in the art, other drawings can be further obtained according to these drawings on the premise of paying no creative work.

FIG. 1 is a flow chart of steps of a preparation method of a gas phase diffusion electrode for electrocatalyzing CO₂ to reduce and produce formic acid provided by an embodiment.

FIGS. 2A, 2B, 2C, and 2D are SEM schematic views based on the conductive polymer-bismuth based catalyst composite material of an embodiment 1.

FIGS. 3A, 3B, 3C, 3D are Faraday efficiency histograms at different current densities of formic acid and hydrogen gas produced by catalyzing and reducing CO₂ by catalyst electrodes of the Embodiment 1 and the Comparative Example 1.

FIG. 4 is a formic acid signal peak of the embodiment 1 under nuclear magnetic resonance (400 HMz) testing conditions.

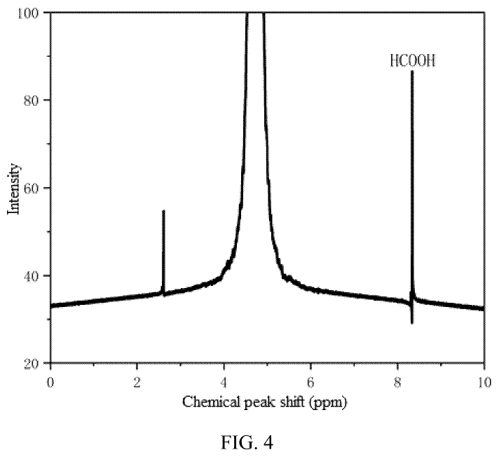

### DETAILED DESCRIPTION

Embodiments of the present application are described in detail below. Examples of the embodiments are shown in the accompanying drawings, wherein the same or similar reference numbers throughout represent the same or similar components or components with the same or similar functions. The embodiments described below with reference to the accompanying drawings are exemplary and intended to explain the present application, but cannot be understood as limiting the present application.

In the description of the present application, it should be understood that the orientations or position relationships indicated by the terms “up”, “down”, “horizontal”, “inside”, “outside”, and the like are orientations or position relationships based on the shown in the accompany drawings, and are only for the convenience of describing the present application and simplifying the description, rather than indicating or implying that the device or element referred to must have a specific orientation, or be constructed and operated in a specific orientation. Therefore, they cannot be understood as any limitation to the present application.

In addition, the terms “first” and “second” are only used for the purpose of description, and cannot be understood as indicating or implying relative importance or implying the quantity of technical features indicated. Therefore, features limited by “first” and “second” can explicitly or implicitly include one or more of these features. In the description of the present application, “multiple” means two or more, unless otherwise specified.

In order to make the purposes, technical solutions, and advantages of the present application be clearer and more understandable, the present application is further illustrated in detail below in combination with the accompany drawings and embodiments.

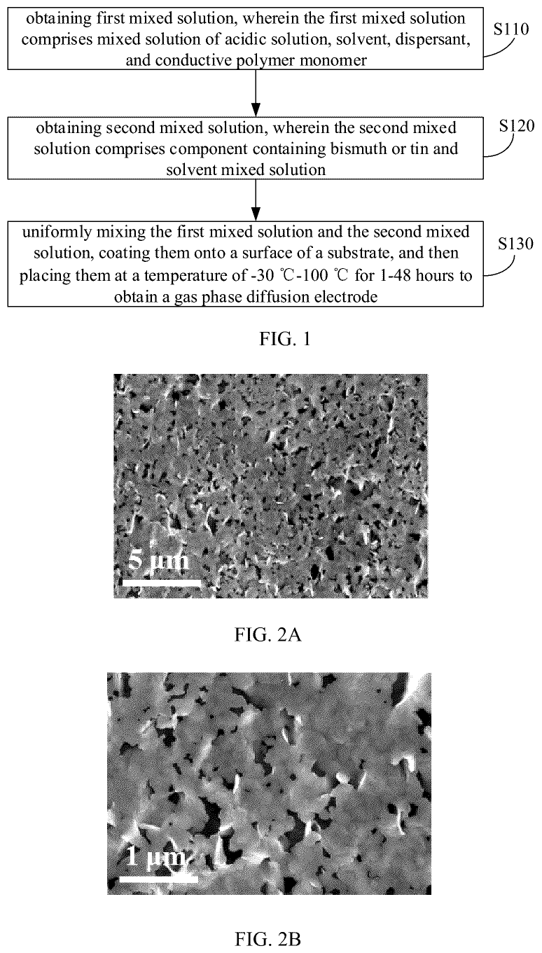

Referring to FIG. 1, which is a flow chart of steps of a preparation method of a gas phase diffusion electrode provided by this embodiment, and includes the following step S110 to step S130. Realizing methods of the steps are explained in detail below.

Step S110: obtaining first mixed solution, wherein the first mixed solution comprises mixed solution of acidic solution, solvent, dispersant, and conductive polymer monomer.

In this embodiment, in the step of obtaining first mixed solution, wherein the first mixed solution comprises mixed solution of acidic solution, solvent, dispersant, and conductive polymer monomer, the molar ratio of the conductive polymer monomer to the acidic solution is 1:1-20.

In this embodiment, the acidic solution comprises one or more of hydrochloric acid, sulfuric acid, nitric acid, formic acid, acetic acid, dodecylbenzenesulfonic acid, p-toluenesulfonic acid, and camphor sulfonic acid.

In this embodiment, the solvent is one or more of water, methanol, ethanol, isopropanol, acetonitrile, ethyl acetate, chloroform, dichloromethane, acetone, N-methylpyrrolidone, dimethylformamide, and dimethyl sulfoxide.

In this embodiment, the conductive polymer monomer is one or more of aniline, pyrrole, thiophene, indole, pyridine, carbazole, dopamine, and p-phenylacetylene monomers.

It can be understood that the conductive polymer monomer provided by the present application has a long-range conjugated structure, and typical conductive polymers include polyacetylene, polypyrrole, polythiophene, polyaniline, and their derivatives. The excellent electrochemical performance of conductive polymers can be utilized to improve surface properties of modified electrodes, such as increasing a specific surface area of an electrode, enhancing conductivity, enhancing electron transfer ability, and providing binding sites for the modification of other materials, etc. More importantly, electrochemical performance of modified electrodes can be improved to further enhance its practical value.

In this embodiment, the dispersant is one or more of isopropanol, methanol, ethanol, ethyl acetate, acetonitrile, N-methylpyrrolidone, and dimethylformamide.

Step S120: obtaining second mixed solution, wherein the second mixed solution comprises component containing bismuth or tin and solvent mixed solution.

In this embodiment, the component containing bismuth or tin comprises one or more of bismuth nitrate, bismuth sulfate, bismuth acetate, bismuth oxycarbonate, bismuth chloride, bismuth bromide, bismuth iodide, bismuth salicylate, bismuth powder, bismuth oxide powder, bismuth sulfide powder, stannous chloride, tin tetrachloride, tin oxide powder, and tin sulfide powder.

In this embodiment, the molar concentration of the component containing bismuth or tin is controlled between 0.01-5 mol/L.

Step S130: uniformly mixing the first mixed solution and the second mixed solution, coating them onto a surface of a substrate, and then placing them at a temperature of −30° C.-100° C. for 1-48 hours to obtain a gas phase diffusion electrode.

Specifically, the first mixed solution and the second mixed solution are mixed uniformly and then coated onto the surface of the substrate by drip coating, or spray coating, or scraping coating, or spin coating, so as to form a continuous and stable coating layer on the surface of the substrate; thus it is placed at a temperature of −30° C.-100° C. for 1-48 hours to obtain the gas phase diffusion electrode.

In this embodiment, the substrate comprises polytetrafluoroethylene, polyethylene, polyvinylidene fluoride, non-woven fabrics, fiber resin films, and modified substrate materials thereof.

In this embodiment, before the step of uniformly mixing the first mixed solution and the second mixed solution, coating them onto a surface of a substrate, the method further comprises: cleaning the substrate several times with water and/or organic solvent, and drying.

It can be understood that conductive macromolecular polymer not only has own ability to transfer charges, but also provides conductive carriers (electrons, ions, or holes) within the macromolecular structure. Carriers are free electrons or holes in polymer, and during a conductive process, the carriers can move directionally within the polymer under the action of an electric field to form a current. After doping, conductivity of structured conductive polymer can significantly increase, and even the conductivity value can be increased to the range of metal's conductivity. A main chain of conductive polymer usually has a conjugated structure, and a polymerization process thereof is mostly oxidative coupling of single ring precursors. When organic compound has a conjugated structure, the π electron system increases, delocalization of electrons increases, and their movable range increases. When the conjugated structure reaches a sufficient size, the compound can provide free electrons and has a conductive function. Therefore, by mixing conductive polymers and active metal components in situ, the polymer and the metal active components are uniformly polymerized and linked on the substrate surface through in-situ polymerization, thereby forming integrated conductive polymer-metal oxide electrode material. This not only can enhance the adhesion force of the metal active components on the surface of the substrate, but also can enhance the conductivity of the substrate material.

The metal-conductive polymer composite gas phase diffusion electrode provided by the present invention can be applied in a reaction system of electrocatalyzing and reducing CO₂ to produce CO.

The preparation method of a gas phase diffusion electrode for electrocatalyzing CO₂ to reduce and produce formic acid obtained by preparation in the above embodiments of the present application includes: obtaining first mixed solution, wherein the first mixed solution comprises mixed solution of acidic solution, solvent, dispersant, and conductive polymer monomer; obtaining second mixed solution, wherein the second mixed solution comprises component containing bismuth or tin and solvent mixed solution; uniformly mixing the first mixed solution and the second mixed solution, coating them onto a surface of a substrate, and then placing them at a temperature of −30° C.-100° C. for 1-48 hours to obtain a gas phase diffusion electrode. Since a main chain of conductive polymer usually has a conjugated structure, and a polymerization process thereof is mostly oxidative coupling of single ring precursors, metal salts with oxidability can be adopted to replace initiators to initiate in-situ polymerization, and catalytic selectivity and stability can be improved by designing metal-conductive polymer composite electrodes. In addition, the gas phase diffusion electrode obtained by preparation in the present application can promote diffusion of CO₂ molecules to a surface of the electrode, and promote the coupling of CO₂ molecules with electrons or protons, such that C═O double bonds are quickly opened, reaction intermediates are formed, and formic acid products with high Faraday efficiency are ultimately generated, thereby achieving circular economic utilization and conversion of carbon dioxide.

The following detailed explanations are all exemplary and intended to provide further explanation of the present invention. Unless otherwise specified, all technical and scientific terms used in this article have the same meanings as those commonly understood by ordinary technical personnel in the technical field to which the present invention belongs.

It should be noted that the terms used herein are only for describing specific embodiments, and are not intended to limit exemplary embodiments according to the present application.

### Embodiment 1

A preparation method of a conductive polymer-bismuth based catalyst composite electrode material for electrocatalyzing CO₂ to reduce and produce formic acid includes the following steps:
(1) preparing polyaniline monomer solution (solution A): taking 0.8 mmol acetic acid solution, adding 0.4 mmol aniline, and then adding 200 μL isopropanol, stirring and mixing evenly, and performing pre-cooling treatment for 2 hours;
(2) preparing bismuth nitrate solution (solution B): taking 0.1 mmol bismuth nitrate solution, adding 100 μL isopropanol, and performing pre-cooling treatment for 2 hours;
(3) preparing Nafion solution: taking 10 μL Nafion, dispersing it in 1000 μL isopropanol, dropwise adding them on a 4×4 cm² PTFE substrate;
(4) uniformly mixing the solution A and the solution B in the Embodiment 1, and quickly dropwise adding them onto a surface of a PTFE carbon film to perform in-situ initiated polymerization reaction; wherein a reaction temperature is 0° C., and a reaction time is 12 hours; preparing to obtain a polyaniline-bismuth based catalyst composite electrode material, which is labeled as Bi-PANI/PTFE composite electrode material.

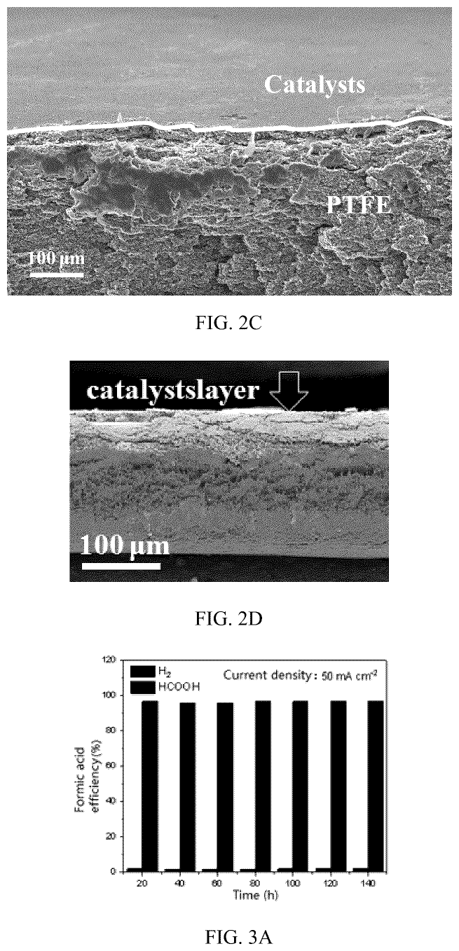

Table 1 shows the electrocatalytic performance of the catalyst sample prepared in Embodiment 1 at different voltages. Furthermore, FIGS. 2A, 2B, 2C, and 2D show SEM schematic views based on the conductive polymer-bismuth based catalyst composite material of the Embodiment 1.

| | | | |
|---|---|---|---|
| Current density/mAcm⁻² | 50 | 100 | 150 |
| Electrolysis time/h | 1.0 | 1.0 | 1.0 |
| Faraday efficiency | 97.2 | 97.9 | 98.5 |
| of formic acid(%) | | | |

### Embodiment 2

A preparation method of a conductive polymer-bismuth based catalyst composite electrode material for electrocatalyzing CO₂ to reduce and produce formic acid includes the following steps:
(1) preparing polypyrrole monomer solution (solution A): taking 0.8 mmol acetic acid solution, adding 0.4 mmol pyrrole, and then adding 200 μL isopropanol, stirring and mixing evenly, and performing pre-cooling treatment for 2 hours;
(2) preparing bismuth nitrate solution (solution B): taking 0.1 mmol bismuth nitrate solution, adding 100 μL isopropanol, and performing pre-cooling treatment for 2 hours;
(3) preparing Nafion solution: taking 10 μL Nafion, dispersing it in 1000 μL isopropanol, dropwise adding them on a 4×4 cm² PTFE carbon film substrate;
(4) uniformly mixing the solution A and the solution B, and quickly dropwise adding them onto a surface of a PTFE substrate to perform in-situ initiated polymerization reaction; wherein a reaction temperature is 0° C., and a reaction time is 12 hours; preparing to obtain a polypyrrole-bismuth based catalyst composite electrode material, which is labeled as Bi-PPy/PTFE composite electrode material.

Table 2 shows the electrocatalytic performance of the catalyst sample prepared in Embodiment 2 at different voltages.

| | | | |
|---|---|---|---|
| Current density/mAcm⁻² | 50 | 100 | 150 |
| Electrolysis time/h | 1.0 | 1.0 | 1.0 |
| Faraday efficiency | 96.0 | 98.2 | 98.8 |
| of formic acid(%) | | | |

### Embodiment 3

A preparation method of a conductive polymer-bismuth based catalyst composite electrode material for electrocatalyzing CO₂ to reduce and produce formic acid includes the following steps:
(1) preparing polythiophene monomer solution (solution A): taking 1.6 mmol acetic acid solution, adding 0.8 mmol pyrrole, and then adding 200 μL isopropanol, stirring and mixing evenly, and performing pre-cooling treatment for 2 hours;
(2) preparing bismuth nitrate solution (solution B): taking 0.1 mmol bismuth nitrate solution, adding 100 μL isopropanol, and performing pre-cooling treatment for 2 hours;
(3) preparing Nafion solution: taking 10 μL Nafion, dispersing it in 1000 μL isopropanol, dropwise adding them on a 4×4 cm² PTFE carbon film substrate;
(4) uniformly mixing the solution A and the solution B, and quickly dropwise adding them onto a surface of a PTFE carbon film to perform in-situ initiated polymerization reaction; wherein a reaction temperature is 0° C., and a reaction time is 12 hours; preparing to obtain a polyaniline-bismuth based catalyst composite electrode material, which is labeled as Bi-PTH/PTFE composite electrode material.

Table 3 shows the electrocatalytic performance of the catalyst sample prepared in Embodiment 3 at different voltages.

| | | | |
|---|---|---|---|
| Current density/mAcm⁻² | 50 | 100 | 150 |
| Electrolysis time/h | 1.0 | 1.0 | 1.0 |
| Faraday efficiency | 85 | 88 | 87 |
| of formic acid(%) | | | |

### Embodiment 4

A preparation method of a conductive polymer-bismuth based catalyst composite electrode material for electrocatalyzing CO₂ to reduce and produce formic acid includes the following steps:
(1) preparing polyacetylene monomer solution (solution A): taking 0.8 mmol acetic acid solution, adding 0.4 mmol aniline, and then adding 200 μL isopropanol, stirring and mixing evenly, and performing pre-cooling treatment for 2 hours;
(2) preparing bismuth nitrate solution (solution B): taking 0.1 mmol bismuth nitrate solution, adding 100 μL isopropanol, and performing pre-cooling treatment for 2 hours;
(3) preparing Nafion solution: taking 10 μL Nafion, dispersing it in 1000 μL isopropanol, dropwise adding them on a 4×4 cm² PTFE substrate;
(4) uniformly mixing the solution A and the solution B, and quickly dropwise adding them onto a surface of a PTFE carbon film to perform in-situ initiated polymerization reaction; wherein a reaction temperature is 0° C., and a reaction time is 12 hours; preparing to obtain a polyaniline-bismuth based catalyst composite electrode material, which is labeled as Bi-PA/PTFE composite electrode material.

Table 4 shows the electrocatalytic performance of the catalyst sample prepared in Embodiment 4 at different voltages.

| | | | |
|---|---|---|---|
| Current density/mAcm⁻² | 50 | 100 | 150 |
| Electrolysis time/h | 1.0 | 1.0 | 1.0 |
| Faraday efficiency | 96 | 98 | 96 |
| of formic acid(%) | | | |

### Embodiment 5

A preparation method of a conductive polymer-bismuth based catalyst composite electrode material for electrocatalyzing CO₂ to reduce and produce formic acid includes the following steps:
(1) preparing polyaniline monomer solution (solution A): taking 1.6 mmol acetic acid solution, adding 0.8 mmol aniline, and then adding 400 μL isopropanol, stirring and mixing evenly, and performing pre-cooling treatment for 2 hours;
(2) preparing bismuth nitrate-tin nitrate solution (solution B): taking 0.4 mmol bismuth nitrate solution and 0.1 mmol tin nitrate solution, adding 800 μL isopropanol, and performing pre-cooling treatment for 2 hours;
(3) preparing Nafion solution: taking 80 μL Nafion, dispersing it in 1000 μL isopropanol, dropwise adding them on a 8×8 cm² PTFE carbon film substrate;
(4) uniformly mixing the solution A and the solution B, and quickly dropwise adding them onto a surface of a PTFE carbon film to perform in-situ initiated polymerization reaction; wherein a reaction temperature is 0° C., and a reaction time is 12 hours; preparing to obtain a polyaniline-bismuth based catalyst composite electrode material, which is labeled as BiSn-PANI/PTFE composite electrode material.

Table 5 shows the electrocatalytic performance of the catalyst sample prepared in Embodiment 5 at different voltages.

| | | | |
|---|---|---|---|
| Current density/mAcm⁻² | 50 | 100 | 150 |
| Electrolysis time/h | 1.0 | 1.0 | 1.0 |
| Faraday efficiency | 93 | 95 | 97 |
| of formic acid(%) | | | |

### Comparative Example 1

Adding 0.296 g Bi(NO₃)₃·5H₂O into 10 mL deionized water; subsequently, adding 1.0M KOH into the above solution and stirring for 2 hours; Washing obtained precipitated Bi₂O₃ three times with deionized water through ultrasound and centrifugation, and dried overnight at 80° C.; taking 30 mg of the Bi₂O₃ catalyst, adding 180 μL 5% Nafion solution and 3 mL 2-propanol, and sonicating for 30 minutes; then dropwise adding them to a surface of a PTFE film and drying; obtaining Bi₂O₃ catalyst electrode material and performing performance evaluation under the same operating conditions in the same electrolysis cell.

Table 6 shows the electrocatalytic performance of the catalyst sample prepared in Comparative Example 1 at different voltages.

| | | | |
|---|---|---|---|
| Current density/mAcm⁻² | 50 | 100 | 150 |
| Electrolysis time/h | 1.0 | 1.0 | 1.0 |
| Faraday efficiency | 70 | 73 | 75 |
| of formic acid(%) | | | |

### Comparative Example 2

Using nano bismuth powder (20 nm) as primary nanoparticle, calcining it at 400° C. for 2 hours in an argon hydrogen mixture atmosphere with a hydrogen volume fraction of 10%. Obtainig elemental bismuth catalyst electrode material, nd performing performance evaluation under the same operating conditions in the same electrolysis cell.

Table 7 shows the electrocatalytic performance of the catalyst sample prepared in Comparative Example 2 at different voltages.

| | | | |
|---|---|---|---|
| Current density/mAcm⁻² | 50 | 100 | 150 |
| Electrolysis time/h | 1.0 | 1.0 | 1.0 |
| Faraday efficiency | 78 | 75 | 82 |
| of formic acid(%) | | | |

### Comparative Example 3

Dissolving 250 mg Bi(NO₃)₃·5H₂O in 20 mL ethylene glycol, stirring, and recording them as solution (1); adding 15 mL oleamine and 15 mL ethanol into the above solution (1), stirring continuously and uniformly, wherein the stirring is continued at room temperature for 12 hours, thereby forming a suspension; wash multiple times with ethanol and deionized water, centrifuging, drying, and performing heat treatment at 300° C. for 2 hours to remove residual oleamine on the surface of BiOₓ-OAₘ; wherein the product is named BiOₓ-300; mixing 1 mg prepared BiOₓ-300 powder with 250 μL ethanol and 6 μL 5% Nafion, and sonicating for 30 minutes to obtain uniform ink; dropping the ink onto PTFE (2.0×2.0 cm²), drying, and using them as cathode electrode material.

Table 8 shows the electrocatalytic performance of the catalyst sample prepared in Comparative Example 3 at different voltages.

| | | | |
|---|---|---|---|
| Current density/mAcm⁻² | 50 | 100 | 150 |
| Electrolysis time/h | 1.0 | 1.0 | 1.0 |
| Faraday efficiency | 85 | 84 | 85 |
| of formic acid(%) | | | |

### Effect Verification

A membrane electrode (MEA) electrolytic cell is used as a CO₂ catalytic reduction reaction device to perform performance evaluation for the bismuth based catalyst electrodes of the Embodiments 1-5 of the present invention and of the Comparative Examples 1-3. The specific measurement conditions are as follows.

Gas products are directly detected by online gas chromatography (GC2014, Shimadzu, Japan) with a sampling interval of 20 minutes. Liquid products are detected through liquid nuclear magnetic resonance (400M): collecting 50 μL liquid products, 500 μL heavy water (D₂O), and 100 μL 6 mM DSS in a nuclear magnetic tube, and mixing them uniformly; mixing 0.1 mL heavy water (D₂O) and 0.1 mL 6 mM DSS in a nuclear magnetic tube uniformly. A standard curve is obtained by preparing and measuring HCOONa·2H₂O and internal standard DSS. A formic acid concentration at each potential is obtained by comparing a peak area ratio of HCOOH and DSS with the standard curve.

A CO₂ electrochemical reduction performance test of the membrane electrode (MEA) electrolytic cell: an anode electrode is an InOₓ/TiO₂ mesh, and the anode is provided with 1 MKOH circulating solution; a cathode is equipped with an electrolysis window with an area of 1.2×1.2, and the cathode is provided with CO₂ humidificatipm gas. In the MEA electrolysis cell, gas and liquid products after electroreduction can directly enter a cathode chamber through a gas diffusion electrode (GDE), the gas products enter the chromatography, and the liquid products are washed and stored in a liquid solution bottle.

Calculation of Faraday efficiency (FE): the Faraday efficiency of formic acid at a given potential is obtained by calculation using the following formula:

$$FEHCOOH = CHCOOH \times V \times N \times F / Q$$

Among them, CHCOOH is the concentration of formic acid in electrolyte; V is a volume of cathode cavity electrolyte; N is the number of electrons transferred from the generated product, for HCOOH, N is equal to 2, F.is Faraday constant: 96485 Coulombs per mole (Cmol); Q is the amount of charge obtained by integrating a current-time curve.

Calculation of formic acid yield: the formic acid yield at a given potential is obtained by calculation using the following formula: VHCOOH═(CHCOOH×V)/(S×t)

Among them, VHCOOH is the formic acid yield; CHCOOH is the concentration of formic acid in the electrolyte; V is the volume of cathode cavity electrolyte; S is a geometric area of the working electrode; t is electric reduction time.

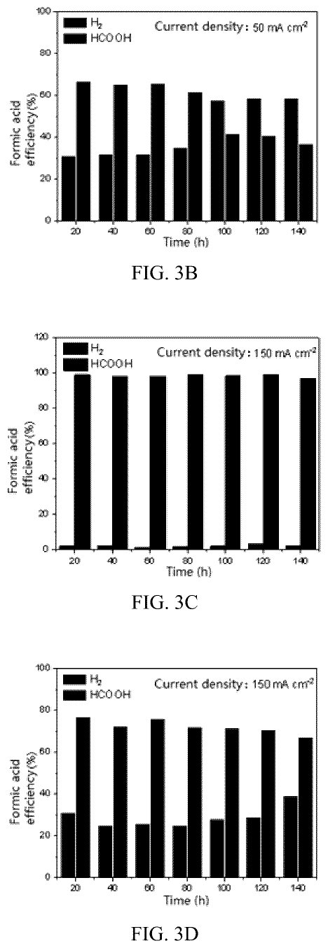

As shown in FIGS. 3A, 3B, 3C, and 3D, it can be seen from Embodiment 1 and Comparative Example 1 that the conductive polymer-bismuth based catalyst provided by the present invention, when being used in the process of CO₂ electroreduction to produce formic acid, maintains high formic acid selectivity (over 96%), while also improves long-term stability, can enable the MEA electrolytic cell to operate continuously and stably for a long time, and maintains stable and high formic acid current efficiency. When other catalytic active components other than bismuth element are introduced, they can synergistically interact with bismuth element, and can further improve the stable operating time of the MEA electrolytic cell.

It can be understood that the various technical features of the above described embodiments can be combined arbitrarily. In order to make the description be concise, all possible combinations of the various technical feature in the above embodiments have not been described. However, as long as there is no contradiction in the combination of these technical features, they should be considered within the scope of this specification.

The above are only preferred embodiments of the present application and only specifically describe the technical principles of the present application. These descriptions are only intended to explain the principles of the present application and cannot be interpreted in any way as limiting the protection scope of the present application. Based on this explanation, any modification, equivalent replacement, and improvement made within the spirit and principles of the present application, as well as other specific implementations of the present application that can be associated without the need for creative labor by technical personnel in this field, shall be included in the protection scope of the present application.

1. A preparation method of a gas phase diffusion electrode for electrocatalyzing CO₂ to reduce and produce formic acid, comprising the following steps:
obtaining first mixed solution, wherein the first mixed solution comprises mixed solution of acidic solution, solvent, dispersant, and conductive polymer monomer;
obtaining second mixed solution, wherein the second mixed solution comprises component containing bismuth or tin and solvent mixed solution;
uniformly mixing the first mixed solution and the second mixed solution, coating them onto a surface of a substrate, and then placing them at a temperature of −30° C.-100° C. for 1-48 hours to obtain a gas phase diffusion electrode.

2. The preparation method of a gas phase diffusion electrode for electrocatalyzing CO₂ to reduce and produce formic acid according to claim 1, wherein in the step of obtaining first mixed solution, wherein the first mixed solution comprises mixed solution of acidic solution, solvent, dispersant, and conductive polymer monomer, the molar ratio of the conductive polymer monomer to the acidic solution is 1:1-20.

3. The preparation method of a gas phase diffusion electrode for electrocatalyzing CO₂ to reduce and produce formic acid according to claim 1, wherein in the step of obtaining first mixed solution, wherein the first mixed solution comprises mixed solution of acidic solution, solvent, dispersant, and conductive polymer monomer, the acidic solution comprises one or more of hydrochloric acid, sulfuric acid, nitric acid, formic acid, acetic acid, dodecylbenzenesulfonic acid, p-toluenesulfonic acid, and camphor sulfonic acid.

4. The preparation method of a gas phase diffusion electrode for electrocatalyzing CO₂ to reduce and produce formic acid according to claim 1, wherein in the step of obtaining first mixed solution, wherein the first mixed solution comprises mixed solution of acidic solution, solvent, dispersant, and conductive polymer monomer, the solvent is one or more of water, methanol, ethanol, isopropanol, acetonitrile, ethyl acetate, chloroform, dichloromethane, acetone, N-methylpyrrolidone, dimethylformamide, and dimethyl sulfoxide.

5. The preparation method of a gas phase diffusion electrode for electrocatalyzing CO₂ to reduce and produce formic acid according to claim 1, wherein in the step of obtaining first mixed solution, wherein the first mixed solution comprises mixed solution of acidic solution, solvent, dispersant, and conductive polymer monomer, the conductive polymer monomer is one or more of aniline, pyrrole, thiophene, indole, pyridine, carbazole, dopamine, and p-phenylacetylene monomers.

6. The preparation method of a gas phase diffusion electrode for electrocatalyzing CO₂ to reduce and produce formic acid according to claim 1, wherein in the step of obtaining first mixed solution, wherein the first mixed solution comprises mixed solution of acidic solution, solvent, dispersant, and conductive polymer monomer, the dispersant is one or more of isopropanol, methanol, ethanol, ethyl acetate, acetonitrile, N-methylpyrrolidone, and dimethylformamide.

7. The preparation method of a gas phase diffusion electrode for electrocatalyzing CO₂ to reduce and produce formic acid according to claim 1, wherein in the step of obtaining second mixed solution, wherein the second mixed solution comprises component containing bismuth or tin and solvent mixed solution, the component containing bismuth or tin comprises one or more of bismuth nitrate, bismuth sulfate, bismuth acetate, bismuth oxycarbonate, bismuth chloride, bismuth bromide, bismuth iodide, bismuth salicylate, bismuth powder, bismuth oxide powder, bismuth sulfide powder, stannous chloride, tin tetrachloride, tin oxide powder, and tin sulfide powder.

8. The preparation method of a gas phase diffusion electrode for electrocatalyzing CO₂ to reduce and produce formic acid according to claim 7, wherein the molar concentration of the component containing bismuth or tin is controlled between 0.01-5 mol/L.

9. The preparation method of a gas phase diffusion electrode for electrocatalyzing CO₂ to reduce and produce formic acid according to claim 1, wherein in the step of uniformly mixing the first mixed solution and the second mixed solution, coating them onto a surface of a substrate, and then placing them at a temperature of −30° C.-100° C. for 1-48 hours to obtain a gas phase diffusion electrode, the coating comprises one of drip coating, spray coating, scraping coating, and spin coating.

10. The preparation method of a gas phase diffusion electrode for electrocatalyzing CO₂ to reduce and produce formic acid according to claim 1, wherein the substrate comprises polytetrafluoroethylene, polyethylene, polyvinylidene fluoride, non-woven fabrics, fiber resin films, and modified substrate materials thereof.

11. The preparation method of a gas phase diffusion electrode for electrocatalyzing CO₂ to reduce and produce formic acid according to claim 10, before the step of uniformly mixing the first mixed solution and the second mixed solution, coating them onto a surface of a substrate, further comprising: cleaning the substrate several times with water and/or organic solvent, and drying.

12. A gas phase diffusion electrode obtained by preparation by the preparation method according to claim 1.

13. An application of a gas phase diffusion electrode according to claim 12 in electrocatalyzing and reduction reaction of CO₂.
